(19) United States
(12) Patent Application Publication
(10) Pub. No.: US 2002/0133822 A1
(43) Pub. Date: Sep. 19, 2002

(54) Method and system for integrating recorded material with electronic programming guide

(76) Inventors: Ivan Wong Yin Yang, Markham (CA); Elena Mate, Toronto (CA); Jitesh Arora, Thornhill (CA)

Correspondence Address: MARKISON & RECKAMP, PC, PO BOX 06229, WACKER DR, CHICAGO, IL, 60606-0229, US

(21) Appl. No.: 09/804,910

(22) Filed: Mar. 13, 2001

(51) Int. Cl. G06F 3/00; H04N 5/445; G06F 13/00

(52) U.S. Cl. 725/49; 725/51; 725/55; 725/40

(57) ABSTRACT

A method and system provides an extended electronic program guide that generates at least one recorded material database of recorded material and that generates a live stream database (or uses a pre-generated live stream database) of live stream data. The live stream database and the recorded material database are integrated to produce an extended electronic program guide. The recorded material can be time shifted data of a predetermined live data stream or can be material derived from a source of digital data.

### FIELD OF THE INVENTION

The present invention relates in general to a system and method for providing an extended electronic program guide, and more particularly to an electronic programming guide that is formed from at least two data bases.

### BACKGROUND OF THE INVENTION

Electronic program guides or electronic programming guides (EPG) are well known in the art and allow consumers to navigate an increasingly complicated array of program choices for cable and satellite television. These electronic program guides and the industry for cable provide on onscreen guide to television programming, as well as allowing a user to point at a program for future recording.

The programming guide displays on the display device, such as a television, a table in which for each channel the scheduled programming is depicted in a present and future time line. In the prior art many devices are known that record television programs in many different formats for storing and replaying at a future date. Such devices can be VCRs, time shifting devices with hard drives, direct digital storage to hard drives, etc. With the large number of channels offered by television services, such as cable and satellite, as well as the number of different types of equipment which can record and store programs such as digital video, the user is posed with significant problem in keeping track of the recorded material.

Therefore, there is a need in the prior art for a unified and orderly method and system for presenting recorded material, as well as live television streams to be integrated into a convenient display for a user.

### BRIEF DESCRIPTION OF THE DRAWINGS

The features of the present invention which are believed to be novel, are set forth with particularity in the appended claims. The invention, together with further objects and advantages, may best be understood by reference to the following description taken in conjunction with the accompanying drawings, in the several figures of which like reference numerals identify like elements.

FIG. 1 is a general block diagram of a system embodying the present invention.

FIG. 2 is a more detailed block diagram of the present invention.

FIG. 3 is a flow chart depicting the steps of one example of a method of the present invention.

FIG. 4 is a flow chart depicting the steps of one example of a method of the present invention.

FIG. 5 is a flow chart depicting the steps of one example of a method of the present invention

FIG. 6 is a flow chart depicting the steps of one example of a method of the present invention.

FIG. 7 is a diagram illustrating an example of a visual grid with entries and a list with existent recorded material for one cell having recorded material linked in accordance with one embodiment of the invention.

### DETAILED DESCRIPTION OF A PREFERRED EMBODIMENT OF THE INVENTION

The present invention is directed to a method for providing an extended electronic program guide. Such a program guide generates at least one recorded material database of recorded material, generates a live stream database of live stream data, and integrates the live stream database with the at least one recorded material database to produce an extended electronic program guide. In general, the system for implementing this method has a plurality of digital material databases or digital material, and a database integrator. The integrator produces an extended electronic program guide from the plurality of digital material databases. Recorded material includes all multimedia related information, such as video streams, stills (like MPEG, JPEG), audio, network links (e.g., addresses or pointers to addresses) to information related to the content of the recorded stream, closed captioning transcriptions and other suitable data.

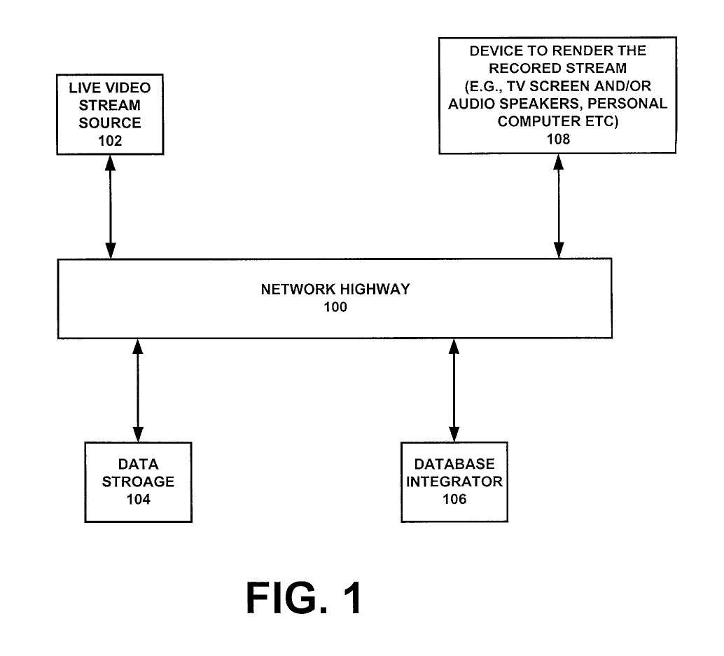

FIG. 1 of the drawings depicts a network highway 100 that is operatively connected to a source of live stream video or multiple sources for live video (for example: picture in picture TVs) 102 and to a data storage device or an array of data storage devices (for example: multiple hard disks, VHS tapes etc.) 104. Also connected to the network highway 100 is a database integrator 106 and device to receive and render the stream (live or recorded) (for example: TV or computer with display and speakers) 108. The database integrator 106 integrates information from the data storage device 104 with information regarding the live data stream of video from the source of live stream video 102 to produce an extended electronic program guide that can be viewed via the device to render the stream 108.

The extended electronic program guide contains not only the programming for each available channel which will occur at some future time, as well as the current programming for that particular channel, but also recorded material at various times in the past that is related to the channels. It is to be understood that material that is to be recorded may be unrelated to a channel of a live video stream and would therefore also be incorporated in this table in the extended electronic program guide under other names besides the channel references.

As is known in the art, the recorded material stored in the data storage device 104 may be time shifted data of predetermined live stream data. Such time shifted data results from systems that can be paused and then restarted during a television program. Such systems then present the program material that occurred during the pause and in some embodiments will gradually catch up with the live video stream. Recorded material may also be video programs that are stored by a VCR or other type of recording device, documents with closed caption transcription, internet links related to that content, still images etc. However, it is to be understood that typically the information stored in the data storage device 104 is digital data related to the stored program material. This is stored in the recorded material database and includes, for example, at least one of identification data and start time (mandatory), and optional ones such as: time recorded, time duration, actors/actresses, rating, and password. The information in the recorded material database is presented in the table format of the extended electronic program guide in a past time line as opposed to the scheduled programs that are to occur in the future on the various channels of the live stream video.

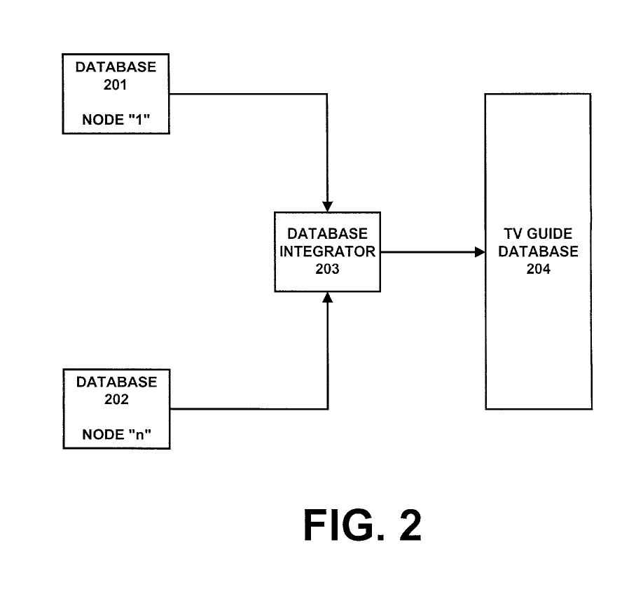

FIG. 2 depicts the present invention as having a plurality of databases 201, 202 referred to as nodes. This plurality of databases may or may not include live stream video, but may be totally composed of recorded material. Typically, however, the first database 201 would contain information regarding a live stream of video that is received by the associated device. Other databases, such as database 202 at node n, would have information regarding stored digital recorded material. It will be recognized that the order is completely irrelevant. The system can have as many live and recorded material databases as desired. The database integrator 203 integrates the information stored in the plurality of databases 201-202 and presents it as an extended electronic program guide to the TV guide database 204. The information then in the TV guide database 204 is displayed on an associated rendering device (display of a television device, for example), in the typical table format that is known for prior art electronic program guides. It is to be understood, however, that the format can take any one of a variety of different formats and does not necessarily require the format of the prior art electronic programming guides.

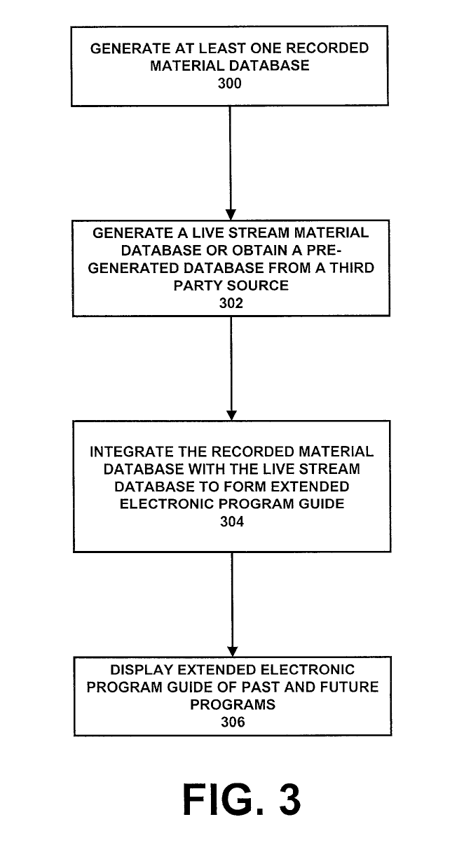

FIG. 3 is a general format flow chart depicting the method of the present invention. The method provides for forming the extended electronic program guide, and in a first step 300 at least one recorded material database is generated for recorded material. In a second step 302 a live stream database is generated for live stream data received by the associated device. In step 304, the live stream data is integrated with recorded material data from each of the respective live stream database and recorded material database to produce the extended electronic program guide. In step 306 the extended electronic program guide is rendered on a rendering device of the associated equipment. The recorded material can be time shifted data for a predetermined live data stream or it may be material which is derived from a source of digital data. Furthermore, a plurality of recorded materials may be present that are derived from respective sources of digital data of a plurality of digital data sources. The information in these different databases is combined to form the extended electronic programming guide.

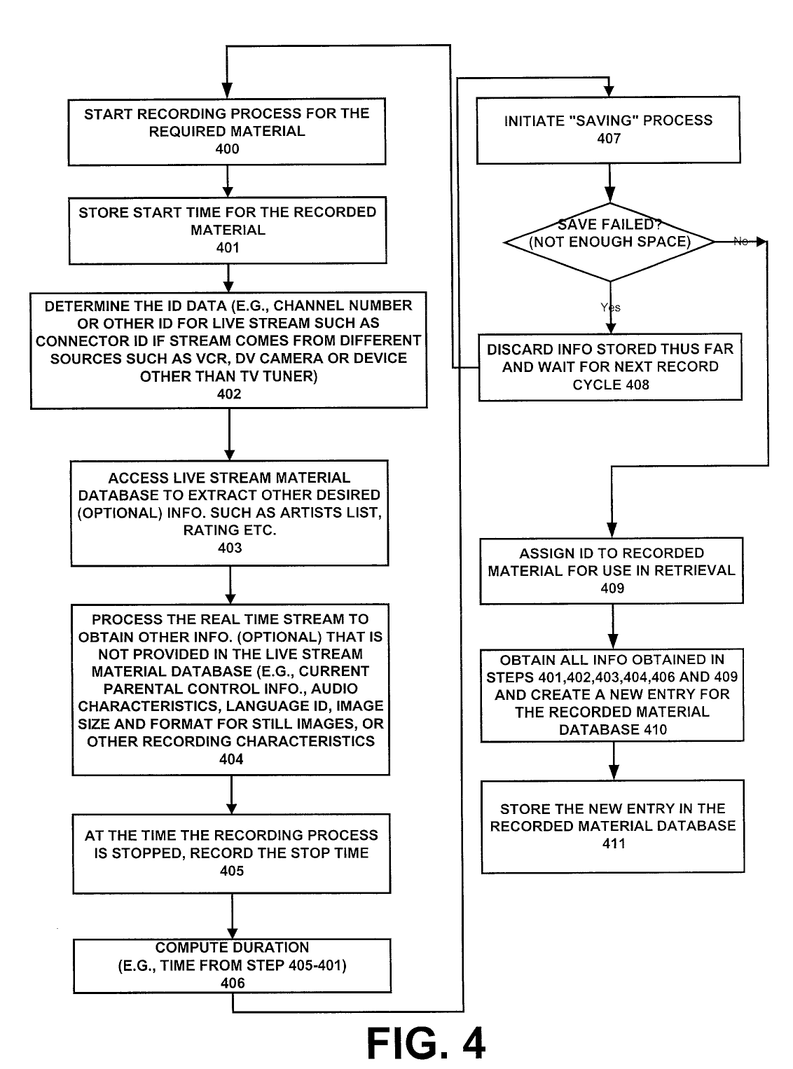

FIG. 4 is a flow chart illustrating one example of a method for creating a recorded material database in accordance with one embodiment in the invention. As shown in block 400, the method includes starting the recording process for the required material. This includes all multimedia related information, such as video streams or stills (example: MPEG, JPEG), audio, network links to information related to the content of the recorded stream, closed captioning transcriptions etc. As shown in block 401, the method includes storing the start time for the recorded material in the database an entry therein. As shown in block 402, the method includes determining the identification data, such as the channel number or any other identification data for the live stream. This may also include, for example, a connector ID if the stream comes from different sources such as a VCR, DV camera or any other device other than the TV tuner.

As shown in block 403, the method includes accessing the live stream material database to extract other desired information, such as an artist list, program rating information, or any other optional information if desired. As shown in block 404, the method includes processing the real time stream to obtain other information that is not provided in the live stream material database. This may include, for example, current parental control information, audio characteristics such as stereo and mono settings, language identifiers, image size information and format information for still images, or other recording characteristics. At the time the recording process is stopped, the method includes recording the stop time as shown in block 405. This may be stored as an entry in the database, or in any other suitable location.

As shown in block 406, the method includes computing the record duration by, for example, subtracting the start time and the stop time as previously stored. As shown in block 407, the method includes initiating the “saving” process. For example, the multimedia stream (live stream) that is captured (as a temporary buffer) has to be saved in the form of recorded material, in the appropriate format (like MPEG, JPEG etc). If the saving process fails, indicating that there is not enough storage space for recorded material or if there is a writing error on the recording device, the method includes, as shown in block 408, discarding the information that was stored thus far and waiting for the next record cycle to start. However, if the live material is successfully stored (recorded), the method includes assigning an identifier to the recorded live material for use in retrieving the recorded material as shown in block 409. As shown in block 410, the method includes obtaining all the information obtained in steps 401, 402, 403, 404, 406 and 409 and creating a new entry in the database for the recorded material database containing this recorded live information. For example, a new entry is stored in the database for the recorded material. The live material database does not have all the information at this point (for example: the identifier to the recorded live material obtained in step 409) Accordingly, as shown in block 411, the method includes storing the new entry in the recorded material database. Accordingly, this is one method carried out, for example, by a software application to create the recorded material database which includes, inter alia, the recorded material, for example, a live stream and material from another stream along with the identifier.

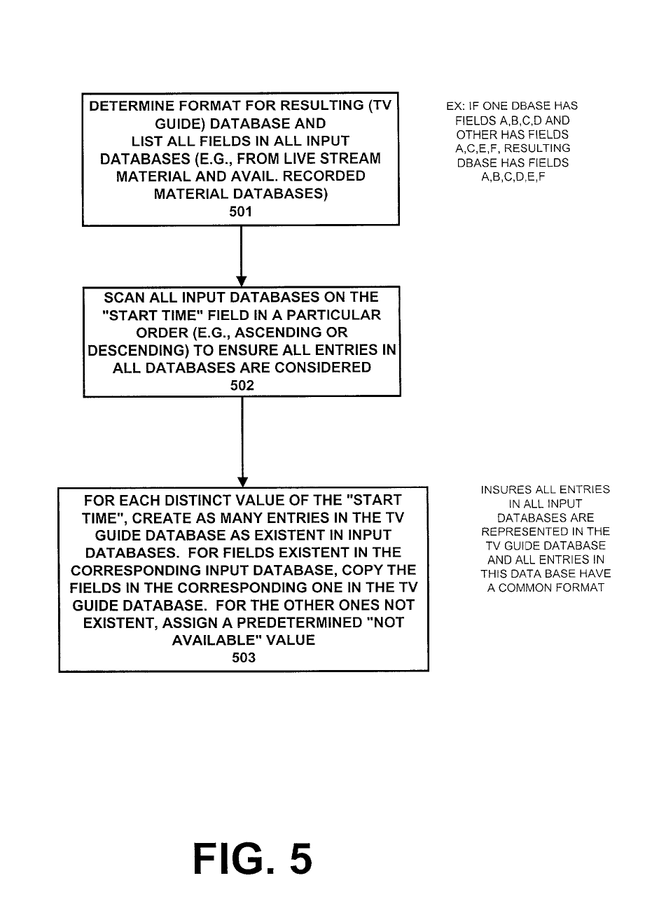

FIG. 5 is a flow chart illustrating one example of a method of operation for the database integrator, which may be, for example, a software application executing on a suitable processing device, or any other suitable hardware, software or firmware combination. As shown in block 501, the method includes determining the format for the resulting database, such as the electronic programming guide. This includes, for example, listing all fields in all input databases such as the fields from the live stream material database and all recorded material databases. For example, if one input database has fields A, B, C and D, and the other database has fields A, C, E and F, the resulting integrated database will have fields A, B, C, D, E and F. Once the format for the resulting integrated database is determined, the method includes, as shown in block 502, scanning all of the input databases on the start time field in the particular order, such as in an ascending or descending order, to insure that all entries from all databases are considered.

As shown in block 503, the method includes, for each distinct value of the start time, creating as many entries in the TV guide database (i.e., the extended electronic program guide) as existent in the input databases. For the fields existent in the corresponding input database, the method includes copying the fields in the corresponding field of the TV guide database. For the other fields that are non-existent for particular a database, a pre-determined “not available” end value is put in those fields. This helps insure that all entries in all input databases are represented in the TV guide database and entries in the extended electronic program guide database will have a common format.

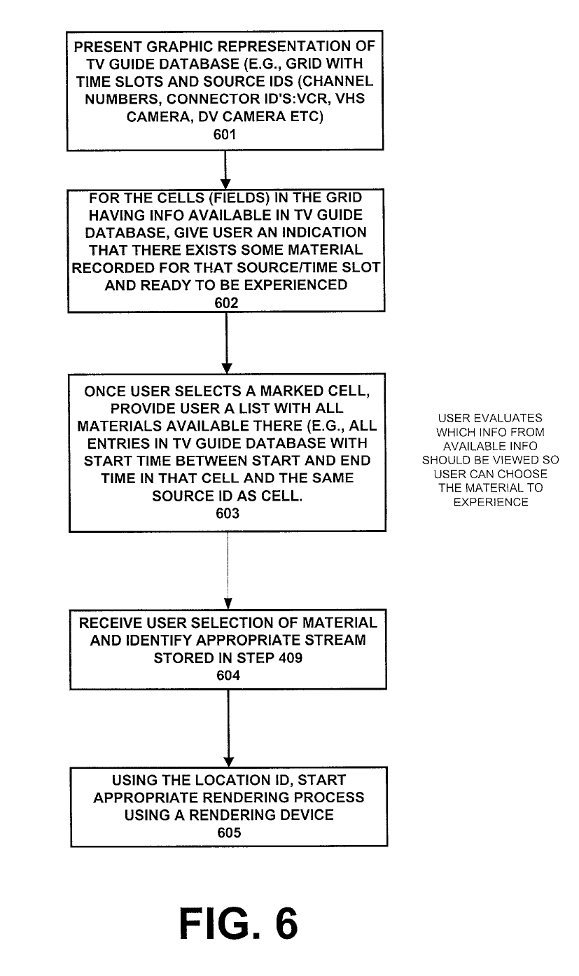

FIG. 6 is a flow chart illustrating one example of the usage for the extended electronic program guide database (i.e., TV guide database) in accordance with one embodiment of the invention. As shown in block 601, the method includes presenting a graphic representation of the TV guide database (for example, as a grid with time slots and source identifiers, such as channel numbers, or connector IDs, for viewing by a user. As shown in block 602, the method includes, for the “cells” or fields in the visual grid, having information available in the TV guide database that includes, for example, giving the user an indication that there exists some material recorded for that source/time slot that is ready to be experienced. As shown in block 603, once the user selects the marked cell, the method includes providing the user a list with all materials available. For example, this may include all entries in the TV guide database with start times between the start and end time in that cell in the same source ID as the cell. The user should be able to configure the information from available information presented by the list in order to help the user decide if this is the material he or she wants to experience. As shown in block 604, the method includes, receiving selected material as selected by the user from the list, and picking the proper stream that is stored that is associated with that material. As shown in block 605, the method includes using the location ID to start the appropriate rendering process for the selected material using the rendering device.

Therefore, the present invention fulfills a need in the prior art and provides an electronic programming guide which shows in a unified table form not only the future programming of live stream video programs, but also shows recorded materials from past dates. The invention is not limited to the particular details of the apparatus depicted, and other modifications and applications are contemplated. Certain other changes may be made in the above-described apparatus and method without departing from the true spirit and scope of the invention herein involved. It is intended, therefore, that the subject matter of the above depiction shall be interpreted as illustrative and not in a limiting sense.

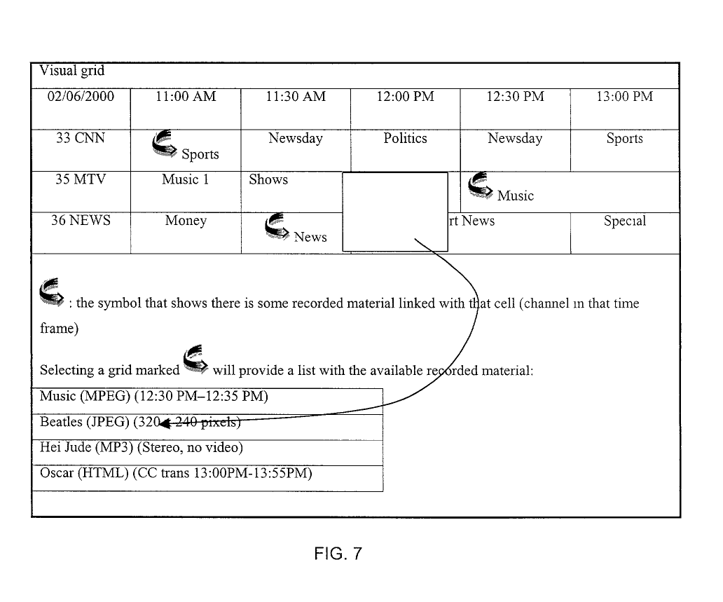

FIG. 7 illustrates one example of a diagram illustrating an example of a visual grid with entries and a list with existent recorded material for one cell having recorded material lined in accordance with one embodiment of the invention.

Therefore, the present invention fulfills a need in the prior art and provides an electronic programming guide which shows in a unified table form not only the future programming of live stream video programs, but also shows recorded materials from past dates.

The invention is not limited to the particular details of the apparatus depicted, and other modifications and applications are contemplated. Certain other changes may be made in the above-described apparatus and method without departing from the true spirit and scope of the invention herein involved. It is intended, therefore, that the subject matter of the above depiction shall be interpreted as illustrative and not in a limiting sense.

What is claimed is:

1. A method for providing an extended electronic program guide, comprising the steps of:
generating at least one recorded material data base of recorded material;
generating a live stream data base or using an existent, pre-generated database, with a known format of live stream data; and
integrating the live stream data base with the at least one recorded material data base to produce an extended electronic program guide.

2. The method according to claim 1, wherein the recorded material includes at least one of: a link to information related to the content of a recorded information stream, video streams, still images, audio streams, and closed captioning information.

3. The method according to claim 1, wherein the recorded material is material derived from a source of digital data.

4. The method according to claim 1, wherein respective recorded material of a plurality of recorded materials is derived from a respective source of digital data of a plurality of digital data.

5. The method according to claim 1, wherein the recorded material data base includes, for predetermined stored recorded material data, identification data, and at least one of optional ones: time recorded, time duration, actors/actresses, rating, and password.

6. A system for providing an extended electronic program guide, comprising:
at least one recorded material data base of recorded material;
a live stream data base of live stream data; and
a data base integrator operatively connected to the at least one recorded material and the live stream data base, the integrator producing an extended electronic program guide from the live stream data and the at least one recorded material data base.

7. The system according to claim 6, wherein the recorded material is time shifted data of predetermined live stream data.

8. The system according to claim 6, wherein the recorded material is material derived from a source of digital data.

9. The system according to claim 6, wherein respective recorded material of a plurality of recorded materials is derived from a respective source of digital data of a plurality of digital data.

10. The system according to claim 6, wherein the recorded material data base includes, for predetermined stored recorded material data, identification data, and at least one of data representing time recorded, time duration, actors/actresses, rating, and password.

11. A system for providing an extended electronic program guide, comprising:
a plurality of digital material data bases of digital material; and
a data base integrator operatively connected to the a plurality of digital material data bases, the integrator producing an extended electronic program guide from the plurality of digital material data bases

12. The system according to claim 11, wherein the digital material is recorded material that is time shifted data of predetermined live stream data.

13. The system according to claim 11, wherein the digital material data base includes, for predetermined stored recorded material data, identification data, and at least one of data representing: time recorded, time duration, actors/actresses, rating, and password.

14. The system according to claim 11, wherein at least one of the digital material is recorded material that is time shifted data of predetermined live stream data.
